(19) United States
(12) Patent Application Publication
(10) Pub. No.: US 2018/0287225 A1
(43) Pub. Date: Oct. 4, 2018

(54) SYSTEM FOR CLOSED LOOP DIRECT COOLING OF A SEALED HIGH VOLTAGE TRACTION BATTERY PACK

(71) Applicant: Ford Global Technologies, LLC, Dearborn, MI (US)

(72) Inventors: Jeffrey Matthew Haag, Dearborn, MI (US); Jason Sielaff, Ann Arbor, MI (US)

(73) Assignee: Ford Global Technologies, LLC, Dearborn, MI (US)

(21) Appl. No.: 15/471,024

(22) Filed: Mar. 28, 2017

(51) Int. Cl. H01M 10/613; H01M 10/625; H01M 10/48; H01M 10/42; H01M 10/6562; H01M 10/6567

(52) U.S. Cl. CPC H01M 10/613; H01M 10/625; H01M 10/486; H01M 2010/4278; H01M 10/6562; H01M 10/6567; H01M 2220/20; H01M 10/425

(57) ABSTRACT

One general aspect includes an electric vehicle (EV) high voltage (HV) battery pack cooling system, including: at least one battery cell positioned in a first compartment of a HV battery pack, where the first compartment is communicatively coupled to a cooling fluid inlet and a cooling fluid outlet positioned on the HV battery pack. The electric vehicle also includes a cooling fluid. The electric vehicle also includes a heat exchanger communicatively coupled to the cooling fluid inlet and the cooling fluid outlet.

### BACKGROUND

This system for closed loop direct cooling of a sealed high voltage traction battery pack is expected to be used as part of the powertrain architecture of hybrid and battery electric vehicles. There are four primary types of such vehicles: full hybrid electric vehicles (FHEVs), plug-in hybrid electric vehicles (PHEVs), battery electric vehicles (BEVs), and fuel cell vehicles (FCVs). FHEVs utilize a high voltage traction battery and electric motor to supplement a traditional internal combustion (IC) engine. PHEVs have a similar system architecture as FHEVs but include the capacity of charging the battery system and also have a larger energy storage capacity, enabling propulsion using only the electric motor. BEVs rely entirely upon a high capacity, high voltage battery and electric motor system, and do not have a traditional IC engine. FCVs convert hydrogen gas and oxygen into electricity to power an electric motor, and include a high voltage battery to recapture energy through regenerative braking and thereby provide supplemental power to the electric motor.

All battery cells generate heat when charging and discharging. This heat must be managed properly in order protect cell life and ensure good performance. A cooling system may be utilized to accomplish this purpose. For traction batteries, the two main types are air-cooled and liquid-cooled systems.

A traditional air-cooled battery uses air as the cooling medium. This type of cooling system is often utilized when the battery pack is packaged in the vehicle interior, where the air being drawn into the pack is both filtered and temperature-controlled by the vehicle's climate control system. The air enters the pack and makes direct contact with the cells to provide convection cooling. This type of cooling system is not suitable for battery packs packaged in the vehicle exterior due to the potentially high ambient air temperatures, high moisture content, and debris to which the battery pack would be exposed.

Traditional liquid-cooled systems use either refrigerant or coolant as the cooling medium. This fluid circulates through a heat exchanger, which is thermally connected with the cells via a thermal interface material, thus providing indirect cooling. Liquid-cooled systems can often provide a higher heat rejection ability than air-cooled systems because the cooling medium has a higher thermal conductivity. Liquid-cooled systems are also more versatile because they can be made to be environmentally sealed, allowing them to be packaged in the vehicle exterior.

### SUMMARY

The proposed direct-cooled system utilizes forced convection with a nonconductive, chemically inert fluid in direct contact with a battery pack's arrays and other heat-generating components in order to provide cooling. The system is comprised of at least three components: a pump, a heat exchanger, and a sealed HV battery pack. The flow path of the cooling fluid may take one of two forms: (1) A compartmentalized system in which the cooling fluid only comes into direct contact with certain heat-generating components of the battery pack, or (2) a flooded system in which the cooling fluid comes into direct contact with all internal components of the battery pack.

### BRIEF DESCRIPTION OF THE DRAWINGS

FIG. 1 is a schematic diagram of a closed loop direct cooling system of a compartmentalized high voltage (HV) traction battery pack.

FIG. 2 is schematic diagram of a closed loop direct cooling system for a HV traction battery pack.

FIG. 3 is a flowchart of a process which may be executed in an electronic control unit (ECU).

### DETAILED DESCRIPTION

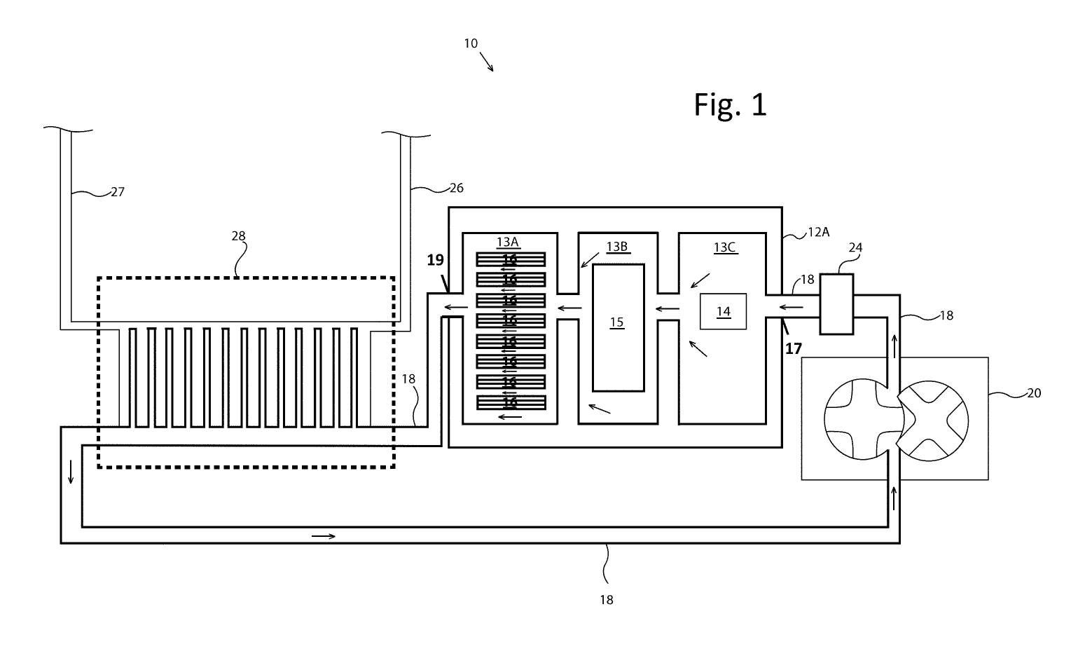

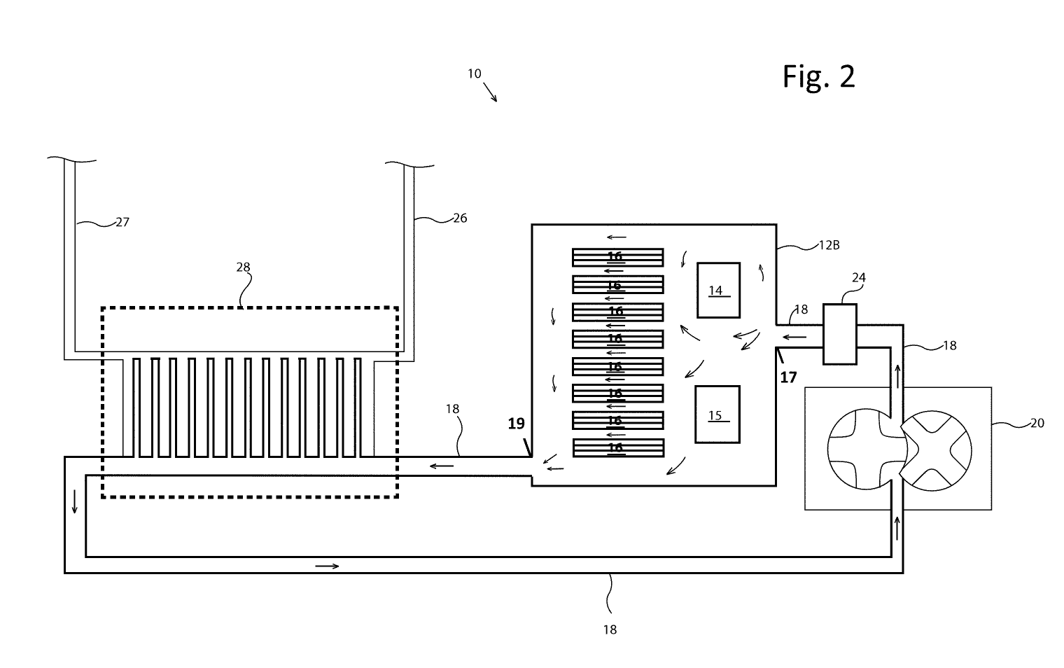

Now with reference to FIGS. 1 and 2, which are examples of a closed loop direct convection HV battery cooling system 10. Although FIG. 1 and FIG. 2 each represent only one embodiment of an electric vehicle (EV) architecture, the disclosed technology may be applied to any type of vehicle that involves a sealed electric vehicle battery or an unsealed HV battery pack.

A HV traction battery pack 12A contains a HV Array 16. The HV Array 16 may be made from a battery cell or a combination of serial and/or parallel battery cells to obtain the voltages and currents required for an EV inverter to drive a traction motor. The HV Array 16 may also be configured with a cooling channel to permit a cooling fluid to flow through the array 16 (between the individual cells). The cooling fluid is pumped through the HV traction battery pack 12A to extract heat from the HV Array 12.

In a first embodiment, the HV traction battery pack 12A is environmentally sealed having a cooling fluid inlet 17 and a cooling fluid outlet 19. The battery pack 12A may further include individual components, such as an electronic control unit (ECU) 14, an electrical distribution circuit 15, and a direct current (DC) to DC converter (not shown). The individual components may be compartmentalized in a compartment 13A, 13B, 13C and subject to forced convection by flowing the cooling fluid through each compartment. The cooling fluid may be an inert gas or an inert fluid which is nonconductive and not chemically reactive.

FIG. 2 illustrates a second embodiment in which the entire battery pack 12B is flooded with the cooling fluid. The individual components are not compartmentalized. The cooling fluid traverses through the battery pack 12B, cools the ECU 14 and electrical distribution circuit 15, also via forced convection of the cooling fluid.

A pump 20 may be communicatively coupled to the ECU 14 to control the circulation of the cooling fluid through the closed loop system 10. The cooling fluid may flow from the pump 20 to the HV traction battery pack 12A 12B via a fluid pathway 18. The pump 20 may be controlled upon instructions sent from the ECU 14 to regulate the temperature of the HV traction battery pack 12A 12B. A filter 24 may be utilized to filter out any impurities which may contaminate the cooling fluid.

The HV traction battery pack 12A 12B cooling fluid may be a gas or a liquid which is neither chemically reactive nor electrically conductive, such as helium, argon, or nitrogen. The cooling fluid may also be a light mixture of higher alkanes from a mineral source, such as a distillate of petroleum, (e.g. a mineral oil). Finally, a silicone oil or a fluorocarbon oil may be utilized to cool the HV traction battery pack 12A 12B.

The ECU 14 may include programming to monitor and control various aspects of the HV Array 16, which may include battery voltage, temperature, and current flow. The ECU 14 may have at least one processor and typically have a memory, e.g., comprising various types of permanent and transient memory such as those known to store computer instructions, register values, and temporary and permanent variables. Further, the ECU 14 may generally include instructions for exchanging data, e.g., from and to a rider or an operator regarding the battery cooling status of the vehicle via a mobile device, a smart phone, a portable computer, a user device and/or Human Machine Interface inside the vehicle.

The electrical distribution circuit 15 comprises a plethora of wiring cables and busses capable of carrying and monitoring the high current provided by of the HV array 16 when powering the vehicle. The electrical distribution circuit 16 may include at least a current sensor, a voltage sensor, a temperature sensor and a coolant flow sensor to monitor the HV traction battery pack 12A 12B when the vehicle is being charged.

The cooling fluid which is output from of the HV traction battery pack 12A 12B may be sent to a heat exchanger 28 to transfer the battery heat from the HV traction battery pack 12A 12B to a first side of the heat exchanger 28. The heat exchanger may be of any type (e.g. a shell and tube heat exchanger, plate heat exchanger, etc.).

A second side of the heat exchanger 28 is communicatively coupled to a heat dissipation circuit (not shown). A heat dissipation circuit may include a circulatory pump connected to an air cooled radiator, a radiator with a Peltier chiller, or a radiator with a heat pipe to dissipate heat.

In an additional embodiment, the heat exchanger 28 may be a cross flow heat exchanger, which does not isolate the closed loop system 10 from the heat dissipation circuit. The cross flow heat exchanger is used to avoid pressure losses and is commonly used for liquid cooling liquid applications when one liquid has a considerably greater flow rate than the other liquid.

### Process Flows

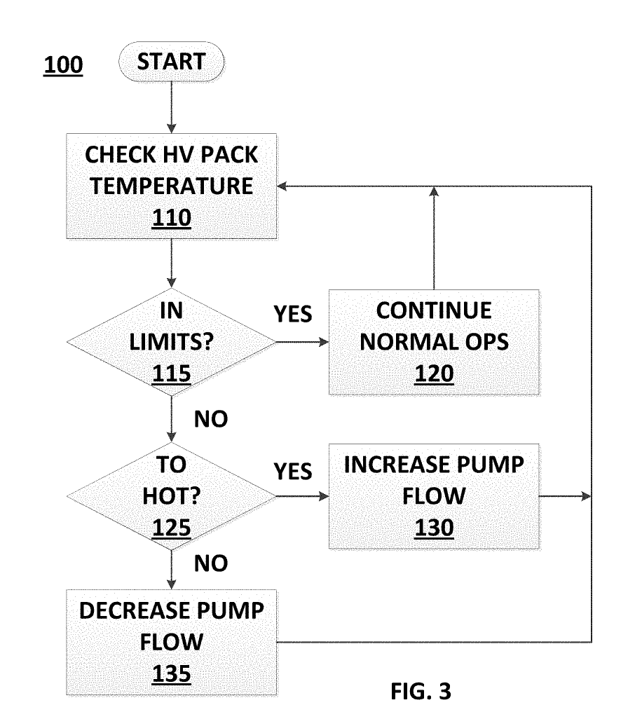

FIG. 3 is a flow chart illustrating an exemplary process 100 that may be executed according to programming in the ECU 14 to detect a temperature within the HV traction battery pack 12A and control the speed of the pump 20 to regulate the cooling of the HV traction battery pack 12A.

A process 100 begins in a block 110. The ECU 14 receives a temperature signal from a sensor positioned in the HV traction battery pack 12A. The signal may be pushed from the temperature sensor and trigger an interrupt in the ECU 14, or alternatively, the ECU 14 may read or request the signal from the temperature sensor.

In a block 115, the ECU 14 determines if the temperature from the HV traction battery pack 12A is within an acceptable range for optimal operation of the battery cells. If the temperature is out of this range, a block 125 is executed. If the temperature is within an acceptable range, a block 120 is executed.

In said block 120, the ECU 14 will not change the speed of the pump 20 and said process 100 returns to said block 110.

In said block 125, the ECU 14 determines if the temperature of the HV traction battery pack 12A is above or below the acceptable range. If the temperature of the HV traction battery pack 12A is higher than acceptable limits, a block 130 is executed. If the temperature of the HV traction battery pack 12A is lower than acceptable limits, a block 135 is executed.

In said block 130, ECU 14 will send a signal to the pump 20 to increase the flow of coolant to lower the temperature of the HV traction battery pack 12A. Said process 100 then continues to said block 110.

In said block 135, ECU 14 will send a signal to the pump 20 to decrease the flow of coolant to raise the temperature of the HV traction battery pack 12A. Said process 100 then returns to said block 110.

### CONCLUSION

As used herein, the adverb “substantially” modifying an adjective means that a shape, structure, measurement, value, calculation, etc. may deviate from an exact described geometry, distance, measurement, value, calculation, etc. because of imperfections in the materials, machining, manufacturing, sensor measurements, computations, processing time, communications time, etc.

Computing devices such as those discussed herein generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination Java™, C, C++, C#, Visual Basic, Python, Java Script, Perl, HTML, PHP, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer may read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. An electric vehicle (EV) high voltage (HV) battery pack cooling system, comprising:
at least one battery cell positioned in a first compartment of a HV battery pack, wherein the first compartment is connected to a cooling fluid inlet and a cooling fluid outlet positioned on the HV battery pack;
a cooling fluid; and
a heat exchanger connected to the cooling fluid inlet and the cooling fluid outlet.

2. The system of claim 1, further comprising an electronic control unit (ECU) positioned in a second compartment positioned in the battery pack, wherein the second compartment is connected to the cooling fluid inlet and the cooling fluid outlet.

3. The system of claim 1, further comprising an electrical distribution circuit positioned in a third compartment in the battery pack, wherein the third compartment is connected to the cooling fluid inlet and the cooling fluid outlet.

4. The system of claim 1, further comprising a filter connected to the cooling fluid inlet and the cooling fluid outlet.

5. The system of claim 1, further comprising a heat exchanger connected to the cooling fluid inlet and the cooling fluid outlet.

6. The system of claim 5, further comprising a pump connected to the cooling fluid inlet and the cooling fluid outlet.

7. The system of claim 6, wherein the heat exchanger is at least one of a shell and tube heat exchanger, a plate heat exchanger, or a cross flow heat exchanger.

8. The system of claim 1, wherein the cooling fluid is an inert gas.

9. The system of claim 1, wherein the cooling fluid is an electrically nonconductive fluid.

10. The system of claim 1, wherein the battery pack is environmentally sealed.

11. An electric vehicle (EV) high voltage (HV) battery pack, comprising:
at least one battery cell positioned in a first compartment of a HV battery pack, an electronic control unit (ECU) positioned in a second compartment, an electrical distribution circuit positioned in a third compartment, wherein the first compartment, the second compartment and the third compartment are connected to a cooling fluid inlet and a cooling fluid outlet positioned on the HV battery pack to flow a cooling fluid through these three compartments.

12. The battery pack of claim 11, wherein a filter is connected to the cooling fluid inlet and the cooling fluid outlet.

13. The battery pack of claim 11, wherein a heat exchanger is connected to the cooling fluid inlet and the cooling fluid outlet.

14. The battery pack of claim 11, wherein a cooling fluid is utilized to cool the battery back is an inert gas.

15. The battery pack of claim 11, wherein a cooling fluid is utilized to cool the battery back is an electrically nonconductive fluid.

16. The battery pack of claim 11, wherein the battery pack is environmentally sealed.

17. A sealed electric vehicle (EV) high voltage (HV) battery pack, comprising:
an at least one battery cell;
an electronic control unit (ECU);
an electrical distribution circuit, wherein the at least one battery cell, the ECU, and the electrical distribution circuit are positioned in a compartment of the battery pack; and
a cooling fluid inlet and a cooling fluid outlet are connected to the compartment to flow a cooling fluid across the battery cell, the ECU, and the electrical distribution circuit.

18. The battery pack of claim 17, wherein a cooling fluid is utilized to cool the battery back is an inert gas.

19. The battery pack of claim 17, further comprising a heat exchanger connected to the cooling fluid inlet and the cooling fluid outlet.

20. The battery pack of claim 17, wherein a cooling fluid is utilized to cool the battery back is an electrically nonconductive fluid.
